(19) United States
(12) Patent Application Publication
(10) Pub. No.: US 2024/0340363 A1
(43) Pub. Date: Oct. 10, 2024

(54) IP DATA PACKET TRANSMISSION METHOD AND APPARATUS AND READABLE STORAGE MEDIUM

(71) Applicant: BEIJING XIAOMI MOBILE SOFTWARE CO., LTD., Beijing (CN)

(72) Inventor: Dong CHEN, Beijing (CN)

(73) Assignee: BEIJING XIAOMI MOBILE SOFTWARE CO., LTD., Beijing (CN)

(21) Appl. No.: 18/681,853

(22) PCT Filed: Aug. 16, 2021
(86) PCT No.: PCT/CN2021/112832

§ 371 Date: Feb. 6, 2024

(51) Int. Cl. H04L 69/22; H04L 69/16

(52) U.S. Cl. CPC H04L 69/22; H04L 69/16

(57) ABSTRACT

An IP data packet transmission method includes: receiving an IP data packet, wherein the IP data packet comprises a preset field, and content of the preset field is indicative of a type of the IP data packet; determining the type of the IP data packet according to the content of the preset field; and performing, on the IP data packet, processing corresponding to the type of the IP data packet.

### CROSS REFERENCE TO RELATED APPLICATION

This application is a national phase application of International Application No. PCT/CN2021/112832, filed on Aug. 16, 2021, which is incorporated by reference herein in its entirety for all purposes.

### BACKGROUND

The IP protocol is widely used in data transmission in the field of mobile communication and the Internet.

The IP protocol can shield the differences of various physical subnets in the lower layer, and provide IP data packets in a unified format to the upper layer. The IP data is transmitted in packets, and the format of IP data packet may be indicative of the function(s) of the IP protocol.

During transmission of the IP data packet, each intermediate node forwards the received IP data packet to the next node. How to improve the transmission process of the IP data packet, so as to meet the newly added usage requirements, is a technical problem that needs to be solved.

### SUMMARY

This disclosure relates to the technical field of wireless communication, and in particular to a method, an apparatus, and a readable storage medium for transmitting Internet Protocol (IP) data packets. In view of above, embodiments of this disclosure provide a method, an apparatus and a readable storage medium for transmitting IP data packets.

According to a first aspect of embodiments of this disclosure, an IP data packet transmission method is provided and applied to a node device in a network, where the node device includes a mobile terminal, and the method includes:
receiving an IP data packet, where the IP data packet includes a preset field, and the preset field is indicative of a type of the IP data packet;
determining the type of the IP data packet according to content of the preset field in the IP data packet; and
performing, according to the type, processing corresponding to the type on the IP data packet.

According to a second aspect of embodiments of this disclosure, a communication device is provided and includes a processor and a memory; where
the memory is configured to store a computer program; and
the processor is configured to execute the computer program, thereby implementing the method according to any embodiments described above.

According to a third aspect of embodiments of this disclosure, a computer-readable storage medium is provided and stores instructions thereon, where the instructions, upon being invoked and executed by a computer, causes the computer to implement the method according to any embodiments described above.

For the beneficial effects of the forgoing second to fourth aspects and possible embodiments thereof, reference may be made to the description of the beneficial effects of the method in the first aspect and any possible embodiments thereof.

It is to be understood that both the foregoing general description and the following detailed description are exemplary and explanatory only and are not restrictive of this disclosure.

### BRIEF DESCRIPTION OF THE DRAWINGS

The accompanying drawings, which are incorporated in and constitute a part of this specification, illustrate examples consistent with the embodiments of the disclosure, and together with the description serve to explain the principles of the embodiments of the disclosure.

FIG. 1 is a schematic diagram of a network transmission system architecture according to some embodiments of present disclosure.

FIG. 2 is a schematic diagram showing the composition of an IP data packet according to some embodiments of present disclosure.

FIG. 3 is a flowchart of an IP data packet transmission method according to some embodiments of present disclosure.

FIG. 4 is a schematic diagram showing the composition of another IP data packet according to some embodiments of present disclosure.

FIG. 5 is a schematic diagram showing the composition of yet another IP data packet according to some embodiments of present disclosure.

FIG. 6 is a flow chart showing another IP data packet transmission method according to some embodiments of present disclosure.

FIG. 7 is a flow chart showing yet another IP data packet transmission method according to some embodiments of present disclosure.

FIG. 8 is a block diagram of an IP data packet transmission apparatus according to some embodiments of present disclosure.

FIG. 9 is a block diagram of another IP data packet transmission apparatus according to some embodiments of present disclosure.

### DETAILED DESCRIPTION

Embodiments of this disclosure will now be further described in conjunction with the accompanying drawings and specific implementation manners.

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of this disclosure. Rather, they are merely examples of apparatuses and methods consistent with aspects of this disclosure as recited in the appended claims.

As shown in FIG. 1, the IP data packet transmission method according to some embodiments of this disclosure may be applied to a network transmission system 100. The network transmission system 100 includes a plurality of transmission nodes, and the transmission nodes may be a node device 101 or a cloud server 102. Herein, according to the transmission direction of the IP data packet, the transmission nodes may include an upstream node or a downstream node.

The upstream node may send IP data packets, and the downstream node may receive IP data packets. Taking the node device 101 being a mobile terminal as an example, the mobile terminal is configured to receive an IP data packet sent by an upstream node.

The forgoing mobile terminal may be user equipment (UE), terminal, access terminal, terminal unit, terminal station, mobile station (MS), remote station, remote terminal, mobile terminal, wireless communication equipment, terminal agent or terminal equipment, or the like. The mobile terminal may be capable of data transmission and receive IP data packets sent by an upstream node.

For example, the mobile terminal may be a cellular phone, a personal digital assistant (PDA) device, a computing device, or a wearable device.

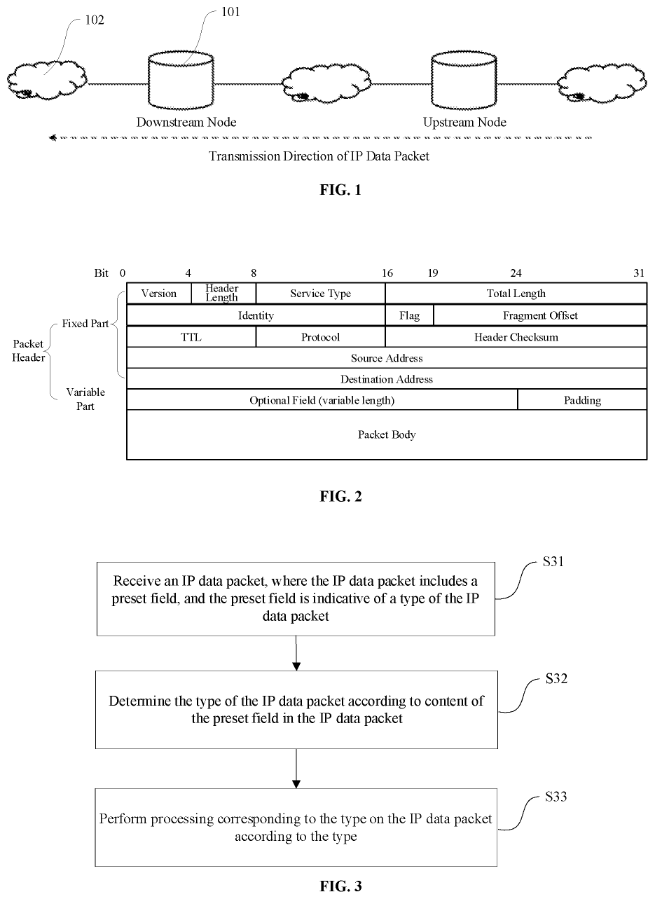

FIG. 2 is a schematic diagram of an IP data packet in the IP protocol. As shown in FIG. 2, the IP data packet in the IP protocol includes: a packet header and a packet body. In some embodiments, the packet header includes: a fixed part and a variable part. The byte length of the fixed part is fixed (e.g., 20 bytes are occupied in total). The byte length of the variable part is variable.

In the fixed part of the IP data packet in the IP protocol, the version field of the IP protocol may occupy 4 bits, the header length field occupies 4 bits, the service type field occupies 8 bits, the total length field occupies 16 bits, the identity field occupies 16 bits, the flag field occupies 3 bits, the fragment offset field occupies 13 bits, the time-to-live (TTL) field occupies 8 bits, the protocol field occupies 8 bits, the header checksum field occupies 16 bits, the source address field occupies 32 bits, and the destination address field occupies 32 bits.

In some embodiments, if the version of the IP protocol is IPV4 or IPV6, the versions of the IP protocol used by both communication parties must be consistent. When using differentiated services, the service type field is functional. The same value of the identity field enables the fragmented data packet fragments to be correctly reassembled into the original data packet at last. The lowest bit in the flag field is indicated as MF (More Fragment), where MF=1 means that there are “fragmented” data packets behind, and MF=0 means that this is the last one of several data packet fragments. The middle bit of the flag field is indicated as DF (Don't Fragment), which means “cannot be fragmented”, and fragmentation is allowed only when DF=0. The fragment offset field indicates the relative position of a certain fragment in the original packet after the lengthy packet is fragmented. The TTL field indicates the lifetime of the data packet in the network. The protocol field indicates which protocol is used for the data carried by the data packet, so that the IP layer of the destination host knows which processing process the data part should be handed over to. The header checksum field only checks the packet header, rather than the packet body, of the data packet.

The variable part includes an optional field. The optional field has a variable length, which may be 1 byte to 40 bytes, and is used to support measures such as debugging, measurement and security. When the optional field includes multiple bytes, the field may be filled with all zeros (0) to form an integer multiple of 4 bytes, without providing any delimiter between the multiple bytes.

Embodiments of this disclosure propose an IP data packet transmission method, which is applied to a node device in a network. The node device may be a mobile terminal. As shown in FIG. 3, FIG. 3 is a flow chart of an IP data packet transmission method according to some embodiments of present disclosure. As shown in FIG. 3, the method according to some embodiments may include the following steps.

In step S31, an IP data packet is received, where the IP data packet includes a preset field, and the preset field is indicative of a type of the IP data packet.

In step S32, the type of the IP data packet is determined according to content of the preset field in the IP data packet.

In step S33, processing corresponding to the type is performed on the IP data packet according to the type.

In some embodiments, the node device is an intermediate node or an end node. In step S31, receiving the IP data packet includes: receiving the IP data packet from an upstream node. In some embodiments, the IP data packet includes a preset field, and the preset field is indicative of the type of the IP data packet.

In some embodiments, the preset field occupies 1 bit, or occupies more than 1 bit.

In some embodiments, the method further includes: generating the IP data packet by an start node, where the IP data packet is configured to include the preset field during the process of generating the IP data packet.

In some embodiments, the types of IP data packets include a first type and a second type. In some embodiments, the first type corresponds to transmission of control information, and the second type corresponds to transmission of service data information. When the content of the preset field in the IP data packet is a first value, the type of the IP data packet is the first type. When the content of the preset field in the IP data packet is a second value, the type of the IP data packet is the second type. In some embodiments, the first value is 1, and the second value is 0. Alternatively, the first value is 0 and the second value is 1.

In some embodiments, different types correspond to different processing. In some embodiments, different types are in one-to-one mapping correspondence with different processing.

In some embodiments, the preset field may be located in the packet header of the IP data packet.

The location of the preset field may vary.

For example, the preset field may occupy several bit(s) at the head or tail of an original field, thereby reducing the number of bits occupied by the original field.

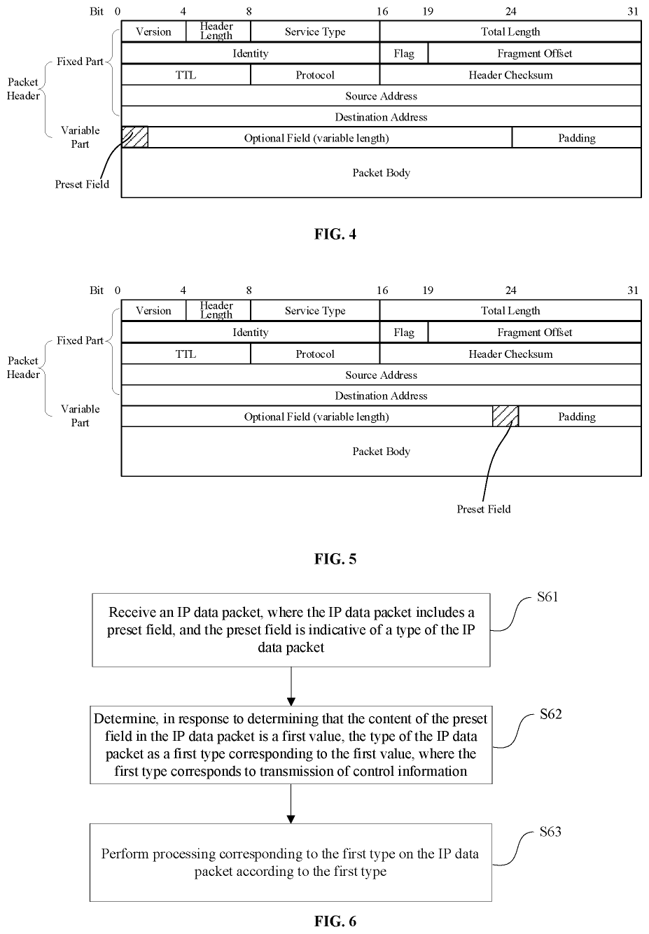

In an example, as shown in FIG. 4, the preset field is located between the destination address field and the optional field in the packet header of the IP data packet.

As shown in FIG. 4, the variable part includes a preset field, an optional field and a padding field. In other words, the preset field is added at the beginning of the variable part of the packet header, and the optional field is located after the preset field.

In an example, as shown in FIG. 5, the preset field is located between the optional field and the padding field in the packet header of the IP data packet.

As shown in FIG. 5, the variable part includes an optional field, a preset field and a padding field. In other words, the preset field is added in the middle of the variable part of the packet header.

According to some embodiments of this disclosure, the node device receives different types of IP data packets, determines the types of IP data packets according to the preset fields in the IP data packets, and performs different processing on different types of IP data packets, thereby improving the function of IP data packets in such a manner that, the IP data packets not only can complete the function of transmitting service data, but also can efficiently utilize the transmission capability of network, so as to meet different usage requirements of user.

Some embodiments of this disclosure propose an IP data packet transmission method, and the method is executed by a node device. As shown in FIG. 6, the method according to some embodiments may include the following steps.

In step S61, an IP data packet is received, where the IP data packet includes a preset field, and the preset field is indicative of a type of the IP data packet.

In step S62, in response to determining that the content of the preset field in the IP data packet is a first value, the type of the IP data packet is determined as a first type corresponding to the first value, where the first type corresponds to transmission of control information.

In step S63, processing corresponding to the first type is performed on the IP data packet according to the first type.

The preset field may be located in the packet header of the IP data packet. The location of the preset field can vary. The specific location of the preset field may refer to each location in the forgoing embodiments, and will not be repeated here.

In some embodiments, in step S63, performing processing corresponding to the first type on the IP data packet according to the first type includes: parsing control information out from the packet body of the IP data packet; and controlling the IP data packet according to the control information.

In some embodiments, the control information includes feature information; where the feature information is feature information of IP data packets meeting a specified criterion.

In an example, the specified criterion includes at least one of the following:
source addresses are the same, destination addresses are the same.

Specifically, the specified criterion is that the source addresses are the same.

Alternatively, the specified criterion is that the destination addresses are the same.

Alternatively, the specified criterion is that the source addresses are the same and the destination addresses are the same.

In an example, when the specified criterion is that the source addresses are the same, the control information includes a source address.

When the specified criterion is that the destination addresses are the same, the control information includes a destination address.

When the specified criterion is that the source addresses are the same and the destination address are the same, the control information includes a source address and a destination address.

In an example, the feature information includes one of the following: a type of service data (e.g., video, image or audio), a sending cycle (e.g., frame information).

In some embodiments, the control information includes a sending policy.

The sending policy includes at least one of the following:
sending according to priorities of the IP data packets,
sending according to versions of the IP data packets,
sending according to service types of the IP data packets.

According to some embodiments of this disclosure, the node device receives different types of IP data packets, determines the types of IP data packets according to the preset fields in the IP data packets, and performs different processing on different types of IP data packets, thereby improving the function of IP data packets in such a manner that, in addition to the ordinary IP data packet, a type of IP data packets is newly proposed to transmit control information. Therefore, the IP data packets not only can complete the function of transmitting service data, but also can be used for transmitting control information, thereby efficiently utilizing the transmission capability of network, and meeting different usage requirements of user.

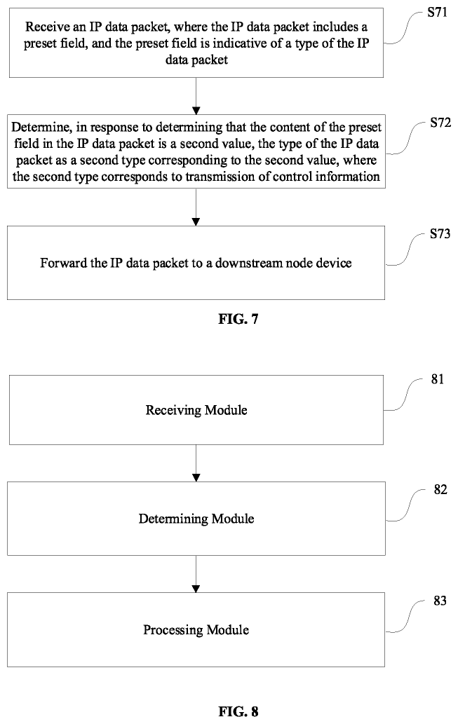

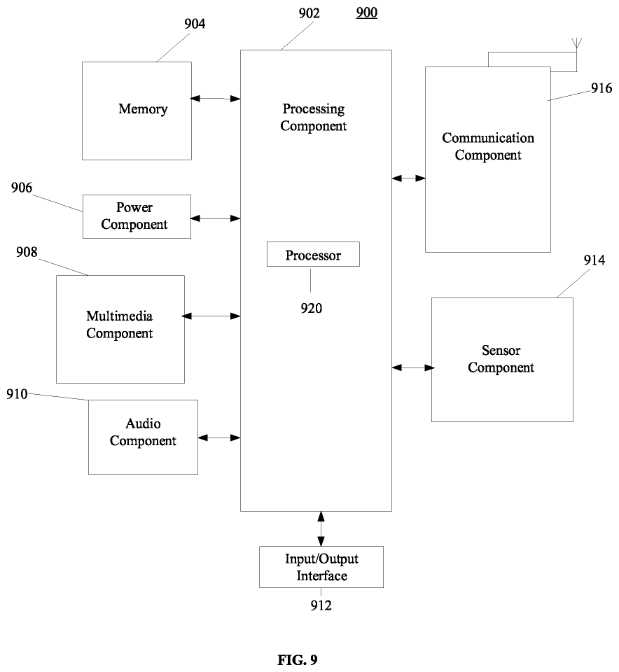

Some embodiments of this disclosure propose an IP data packet transmission method, and the method is executed by a node device. As shown in FIG. 7, the method according to some embodiments may include the following steps.

In step S71, an IP data packet is received, where the IP data packet includes a preset field, and the preset field is indicative of a type of the IP data packet.

In step S72, in response to determining that the content of the preset field in the IP data packet is a second value, the type of the IP data packet is determined as a second type corresponding to the second value, where the second type corresponds to transmission of service data information.

In step S73, the IP data packet is forwarded to a downstream node device.

In some embodiments, the downstream node device belongs to a routing path, and the routing path is used to reach the destination address in the IP data packet.

The preset field may be located in the packet header of the IP data packet. The location of the preset field can vary. The specific location of the preset field may refer to each location in the forgoing embodiments, and will not be repeated here.

According to some embodiments of this disclosure, when the content of the preset field in the IP data packet indicates that it is used to transmit service data information, the IP data packet is determined as an ordinary IP data packet, and the IP data packet is directly forwarded to the downstream node device without necessity to carry out control on the IP data packet other than forwarding the same.

Some embodiments of this disclosure propose an IP data packet transmission apparatus, which is applied to a node device in a network, and the node device may be a mobile terminal. As shown in FIG. 8, FIG. 8 is a block diagram of an IP data packet transmission apparatus according to some embodiments of present disclosure. As shown in FIG. 8, the apparatus according to some embodiments may include:
a receiving module 81, configured to receive an IP data packet, where the IP data packet includes a preset field, and the preset field is indicative of a type of the IP data packet;
a determining module 82, configured to determine the type of the IP data packet according to content of the preset field in the IP data packet; and
a processing module 83, configured to perform, according to the type, processing corresponding to the type on the IP data packet.

In some embodiments, the preset field is located in a packet header of the IP data packet.

In some embodiments, the preset field is located between the destination address field and the optional field in the packet header of the IP data packet.

Some embodiments of this disclosure propose an IP data packet transmission apparatus, which is applied to a node device in a network, and the node device may be a mobile terminal. The apparatus according some embodiments may include the apparatus shown in FIG. 7.

The determining module 82 is further configured to determine the type of the IP data packet according to the content of the preset field in the IP data packet through a following manner:
determining, in response to determining the content of the preset field in the IP data packet being a first value, the type of the IP data packet as a first type corresponding to the first value, where the first type corresponds to being used for transmitting control information.

Some embodiments of this disclosure propose an IP data packet transmission apparatus, which is applied to a node device in a network, and the node device may be a mobile terminal. The apparatus according some embodiments may include the apparatus shown in FIG. 8.

The processing module 83 includes:
a parsing module, configured to parse the control information out from a packet body of the IP data packet; and
a controlling module, configured to control the IP data packet according to the control information.

In some embodiments, the control information includes feature information, and the feature information is feature information of IP data packets meeting a specified criterion.

In some embodiments, the specified criterion includes at least one of following: source addresses are the same, destination addresses are the same;
the control information includes at least one of following: a source address, a destination address.

In some embodiments, the feature information includes at least one of following: a sending cycle, a type of service data.

In some embodiments, the control information includes a sending policy for a preset type of IP data packets.

In some embodiments, the sending policy includes at least one of following:
sending according to priorities of the IP data packets,
sending according to versions of the IP data packets,
sending according to service types of the IP data packets.

Some embodiments of this disclosure propose an IP data packet transmission apparatus, which is applied to a node device in a network, and the node device may be a mobile terminal. The apparatus according some embodiments may include the apparatus shown in FIG. 8.

The determining module 82 is further configured to determine the type of the IP data packet according to the content of the preset field in the IP data packet through a following manner:
determining, in response to determining the content of the preset field in the IP data packet being a second value, the type of the IP data packet as a second type corresponding to the second value, where the second type corresponds to being used for transmitting service data information;

The processing module 83 further includes:
a forwarding module, configured to forward the IP data packet to a downstream node device.

FIG. 9 is a schematic diagram of a communication device. The communication device 900 may be a mobile terminal. The communication device 900 may be a mobile phone, a computer, a digital broadcast terminal, a messaging device, a game console, a tablet device, a medical device, a fitness device, a personal digital assistant, and the like.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 generally controls the overall operation of the device 900, such as operations associated with display, phone calls, data communications, camera operations, and recording operations. The processing component 902 may include one or more processors 920 to execute instructions to perform all or some of the steps of the methods described above. Additionally, the processing component 902 may include one or more modules that facilitate interaction between the processing component 902 and other components. For example, the processing component 902 may include a multimedia module to facilitate interaction between the multimedia component 908 and the processing component 902.

The memory 904 is configured to store various types of data to support operation at the device 900. Examples of such data include instructions, contact data, phonebook data, messages, pictures, videos, and the like for any application or method operating on the device 900. The memory 904 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 906 provides power to various components of the device 900. The power components 906 may include a power management system, one or more power sources, and other components associated with generating, managing, and distributing power to the device 900.

The multimedia component 908 includes a screen that provides an output interface between the device 900 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 908 includes a front camera and/or a rear camera. When the device 900 is in an operation mode, such as a shooting mode or a video mode, the front camera and/or the rear camera may receive external multimedia data. Each of the front and rear cameras may be a fixed optical lens system or have focal length and optical zoom capability.

The audio component 910 is configured to output and/or input audio signals. For example, the audio component 910 includes a microphone (MIC) that is configured to receive external audio signals when the device 900 is in operating modes, such as calling mode, recording mode, and voice recognition mode. The received audio signal may be further stored in the memory 904 or transmitted via the communication component 916. In some embodiments, the audio component 910 also includes a speaker for outputting audio signals.

The I/O interface 912 provides an interface between the processing component 902 and a peripheral interface module, which may be a keyboard, a click wheel, a button, or the like. These buttons may include, but are not limited to: home button, volume buttons, start button, and lock button.

The sensor assembly 914 includes one or more sensors for providing status assessments of various aspects of the device 900. For example, the sensor assembly 914 can detect the open/closed state of the device 900, the relative positioning of components, such as the display and keypad of the device 900. The sensor assembly 914 can also detect a change in the position of the device 900 or a component of the device 900, the presence or absence of user contact with the device 900, the orientation or acceleration/deceleration of the device 900, and the temperature change of the device 900. The sensor assembly 914 may include a proximity sensor configured to detect the presence of nearby objects in the absence of any physical contact. The sensor assembly 914 may also include a light sensor, such as a CMOS or CCD image sensor, for use in imaging applications. In some embodiments, the sensor assembly 914 may also include an acceleration sensor, a gyroscope sensor, a magnetic sensor, a pressure sensor, or a temperature sensor.

The communication component 916 is configured to facilitate wired or wireless communication between the device 900 and other devices. The device 900 may access wireless networks based on communication standards, such as WiFi, 2G or 3G, or a combination thereof. In some embodiments, the communication component 916 receives broadcast signals or broadcast related information from an external broadcast management system via a broadcast channel. In some embodiments, the communication component 916 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the device 900 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the forgoing methods.

In some embodiments, there is also provided a non-transitory computer-readable storage medium including instructions, such as the memory 904 including instructions, executable by the processor 920 of the device 900 to perform the method described above. For example, the non-transitory computer-readable storage medium may be ROM, random access memory (RAM), CD-ROM, magnetic tape, floppy disk, optical data storage device, and the like.

Other embodiments of this disclosure will readily occur to those skilled in the art upon consideration of the specification and practice of the invention disclosed herein. This application is intended to cover any variations, uses, or adaptations of this disclosure that follow the general principles of this disclosure and include common knowledge or techniques in the technical field not disclosed by this disclosure. The specification and examples are to be regarded as exemplary only, with the true scope and spirit of the disclosure being indicated by the following claims.

It is to be understood that this disclosure is not limited to the precise structures described above and illustrated in the accompanying drawings, and that various modifications and changes may be made without departing from the scope thereof. The scope of this disclosure is limited only by the appended claims.

### INDUSTRIAL APPLICABILITY

The node device receives different types of IP data packets, determines the types of IP data packets according to the preset fields in the IP data packets, and performs different processing on different types of IP data packets, thereby improving the function of IP data packets in such a manner that, the IP data packets not only can complete the function of transmitting service data, but also can meet different usage requirements.

1. An Internet Protocol (IP) data packet transmission method, performed by a node device in a network, wherein the node device comprises a mobile terminal, and the method comprises:
receiving an IP data packet, wherein the IP data packet comprises a preset field, and content of the preset field is indicative of a type of the IP data packet;
determining the type of the IP data packet according to the content of the preset field; and
performing, on the IP data packet, processing corresponding to the type of the IP data packet.

2. The IP data packet transmission method as claimed in claim 1, wherein,
the determining the type of the IP data packet according to the content of the preset field comprises:
determining, in response to determining that the content of the preset field is a first value, the type of the IP data packet as a first type, wherein the first type IP data packet is configured for transmitting control information.

3. The IP data packet transmission method as claimed in claim 2, wherein,
the performing, on the IP data packet, processing corresponding to the type of the IP data packet comprises:
parsing the control information out from a packet body of the IP data packet; and
controlling the IP data packet according to the control information.

4. The IP data packet transmission method as claimed in claim 3, wherein,
the control information comprises feature information of IP data packets that meets a specified criterion.

5. The IP data packet transmission method as claimed in claim 4, wherein,
the specified criterion comprises at least one of following: source addresses are the same, or destination addresses are the same; and
the control information comprises at least one of following: a source address or a destination address.

6. The IP data packet transmission method as claimed in claim 4, wherein,
the feature information comprises at least one of following: a sending cycle or a type of service data.

7. The IP data packet transmission method as claimed in claim 3, wherein,
the control information comprises a sending policy for a preset type of IP data packets.

8. The IP data packet transmission method as claimed in claim 7, wherein,
the sending policy comprises at least one of following:
sending according to priorities of the IP data packets,
sending according to versions of the IP data packets, or
sending according to service types of the IP data packets.

9. The IP data packet transmission method as claimed in claim 1, wherein,
the determining the type of the IP data packet according to the content of the preset field comprises:
determining, in response to determining that the content of the preset field is a second value, the type of the IP data packet as a second type, wherein the second type IP data packet is configured for transmitting service data information; and
performing, on the IP data packet, processing corresponding to the type of the IP data packet comprises:
forwarding the IP data packet to a downstream node device.

10. The IP data packet transmission method as claimed in claim 1, wherein,
the preset field is located in a packet header of the IP data packet.

11. The IP data packet transmission method as claimed in claim 10, wherein,
the preset field is located between a destination address field and an optional field in the packet header.

12-23. (canceled)

24. A computer-readable storage medium storing instructions thereon, wherein the instructions, upon being invoked and executed by a computer, causes the computer to implement an Internet Protocol (IP) data packet transmission method, and the method comprises:
receiving an IP data packet, wherein the IP data packet comprises a preset field, and content of the preset field is indicative of a type of the IP data packet;
determining the type of the IP data packet according to the content of the preset field; and
performing, on the IP data packet, processing corresponding to the type of the IP data packet.

25. A communication device, comprising a processor and a memory; wherein
the memory is configured to store a computer program; and
the processor, through executing the computer program, is configured to perform acts comprising:
receiving an IP data packet, wherein the IP data packet comprises a preset field, and content of the preset field is indicative of a type of the IP data packet;
determining the type of the IP data packet according to the content of the preset field; and
performing, on the IP data packet, processing corresponding to the type of the IP data packet

26. The communication device as claimed in claim 25, wherein the processor is further configured to:
determine, in response to determining that the content of the preset field is a first value, the type of the IP data packet as a first type, wherein the first type is configured for transmitting control information.

27. The communication device as claimed in claim 26, wherein the processor is further configured to perform acts comprising:
parsing the control information out from a packet body of the IP data packet; and
controlling the IP data packet according to the control information.

28. The communication device as claimed in claim 27, wherein,
the control information comprises feature information of IP data packets that meets a specified criterion.

29. The communication device as claimed in claim 28, wherein,
the specified criterion comprises at least one of following: source addresses are the same, or destination addresses are the same; and
the control information comprises at least one of following: a source address or a destination address.

30. The communication device as claimed in claim 28, wherein,
the feature information comprises at least one of following: a sending cycle or a type of service data.

31. The communication device as claimed in claim 27, wherein,
the control information comprises a sending policy for a preset type of IP data packets; and
the sending policy comprises at least one of following:
sending according to priorities of the IP data packets,
sending according to versions of the IP data packets, or
sending according to service types of the IP data packets.

32. The communication device as claimed in claim 25, wherein the processor is further configured to perform acts comprising:
determining, in response to determining that the content of the preset field is a second value, the type of the IP data packet as a second type, wherein the second type is configured for transmitting service data information; and
forwarding the IP data packet to a downstream node device.
